(19) United States
(12) Patent Application Publication
(10) Pub. No.: US 2023/0420992 A1
(43) Pub. Date: Dec. 28, 2023

(54) DISTRIBUTED WIRELESS CHARGING AND TRACKING NETWORK FOR MEDICAL APPLIANCES

(71) Applicant: Yank Technologies, Inc., Brooklyn, NY (US)

(72) Inventor: Joshua Aaron YANKOWITZ, Brooklyn, NY (US)

(73) Assignee: Yank Technologies, Inc., Brooklyn, NY (US)

(21) Appl. No.: 18/252,858

(22) PCT Filed: Nov. 19, 2021
(86) PCT No.: PCT/US2021/072528

§ 371 Date: May 12, 2023

Related U.S. Application Data
(60) Provisional application No. 63/116,006, filed on Nov. 19, 2020.

(51) Int. Cl. H02J 50/12; H02J 50/40; H02J 50/80

(52) U.S. Cl. CPC H02J 50/12; H02J 50/402; H02J 50/80

(57) ABSTRACT

The described technology provides a wireless charging network comprising wireless power transmitters and wireless power transmitter nodes distributed in various physically separate locations in a medical facility. The wireless power transmitters are configured to communicate with a controller and/or database to indicate when a medical device is near the wireless power transmitter. The wireless power transmitters or the wireless receivers also communicate with a controller and/or database to indicate charging status of the medical devices.

### CROSS-REFERENCE TO RELATED APPLICATIONS

This patent document claims priority to and benefit from U.S. Provisional Patent Application No. 63/116,006, entitled “DISTRIBUTED WIRELESS CHARGING AND TRACKING NETWORK FOR MEDICAL APPLIANCES,” filed on Nov. 19, 2020, which is hereby incorporated by reference in its entirety.

### TECHNICAL FIELD

The present application relates to distributed wireless charging networks.

### BACKGROUND

The cost per minute in the operating rooms (OR) of hospitals can be quite high (some estimates put it at around $133/minute). Because of such a high cost, it is important that the medical appliances or equipment used in medical facilities (e.g., surgical tools) be available and ready for use because every minute wasted costs the medical facilities large amounts of money. For example, some estimates place the average ultrasound procedure cost at around $374 and the duration of the procedure at around thirty minutes. As a result, every time an ultrasound machine dies or is idle (e.g., batteries in portable ultrasound machine runs out of charge), the hospital stands to lose as much as $748/hour of revenue. These losses trickle down to patients resulting in increased costs of medical services. It is therefore beneficial to have a wireless charging system that can wirelessly charge and track medical equipment located in different locations within a medical facility in a way that enhances the uptime and utilization of the medical equipment.

### BRIEF DESCRIPTION OF THE DRAWINGS

FIG. 1 is a representative block diagram of a wireless power transmitter system.

FIG. 2 is a representative block diagram of a wireless power transmitter node.

FIG. 3 is a representative block diagram of a distributed wireless charging network.

FIG. 4 is a representative block diagram of a wireless charging communication network.

FIG. 5 is a block diagram that illustrates an example of a computer system in which at least some operations described herein can be implemented.

FIG. 6 is a flowchart that illustrates a process for supplying power to a moveable object based on proximity to wireless power transmitters.

### DETAILED DESCRIPTION

A wireless charging network is disclosed which includes wireless power transmitters (i.e., wireless charging transmitters) located in separate spatial locations in a medical facility (e.g., different rooms in a hospital). The wireless charging network communicates with a controller or database to indicate the locations of medical devices (or other moveable objects) within the medical facility (e.g., based on the proximity of the medical device to a wireless power transmitter). The wireless power transmitter or the medical device can also communicate charge status of the paired medical devices (or medical devices previously paired) and other information to the controller or database. The distributed wireless charging network can thereby charge and track the medical appliances to improve their usage and uptime.

The distributed wireless charging network includes transmitters that are separately distributed in different locations within the medical facility (e.g., in different operating rooms and patient rooms) to create individual charging hotspots in the facility. The distributed wireless charging network can be actively monitored in real-time to provide actionable intelligence, for example, information useful to hospital administration to make better purchasing decisions based on equipment usage, and information useful to medical professionals (e.g., doctors and nurses) to improve the utilization and uptime of the medical equipment.

Various embodiments will now be described. The following description provides specific details for a thorough understanding and an enabling description of these embodiments. One skilled in the art will understand, however, that the disclosed techniques can be practiced without many of these details. Additionally, some well-known structures or functions may not be shown or described in detail, to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

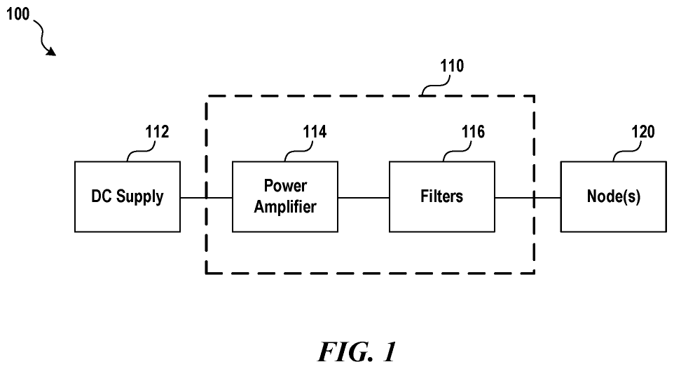

FIG. 1 is a representative block diagram of a wireless power transmitter system 100. In some embodiments, the wireless power transmitter system 100 includes a direct current (DC) supply 112 coupled to one or more wireless power transmitter circuits 110. The wireless power transmitter circuit 110 is coupled to one or more wireless power transmitter nodes 120. Multiple wireless power transmitter systems 100 are distributed in various locations within the medical facility, e.g., allocated in various rooms of a hospital with at least one wireless power transmitter system 100 per room.

The DC supply 112 powers a power amplifier 114 (e.g., parallel resonant amplifiers), and filters 116 to reduce harmonics and electromagnetic interference (EMI) (i.e., for electromagnetic compatibility (EMC)).

The output of the wireless power transmitter circuit 110 is coupled to one or more wireless power transmitter nodes 120. Depending on the circuit components and amplifier topology of the wireless power transmitter circuit 110, there may be multiple nodes 120 for a single wireless power transmitter system 100. The number of nodes 120 and the distance between the nodes can vary according to the layout of the room in which they are placed.

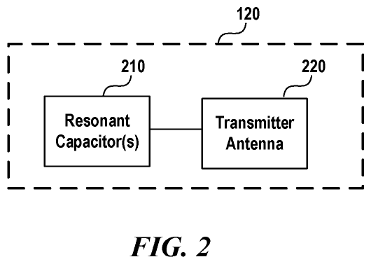

FIG. 2 is a representative block diagram of a wireless power transmitter node 120. In some embodiments, the wireless power transmitter node 120 is an inductor-capacitor circuit (e.g., an LC tank circuit) including resonant capacitors 210 and a transmitter antenna 220 tuned to the operating frequency of the wireless power transmitter. A system can include multiple wireless power transmitter circuits (e.g., multiple transmitter circuit 110 in FIG. 1) with each wireless power transmitter circuit having multiple wireless power transmitter nodes 120. Each one of the wireless power transmitter nodes includes one or more resonant capacitors tuned to substantially excite each the transmitter antennas at an operating frequency of the wireless power transmitters.

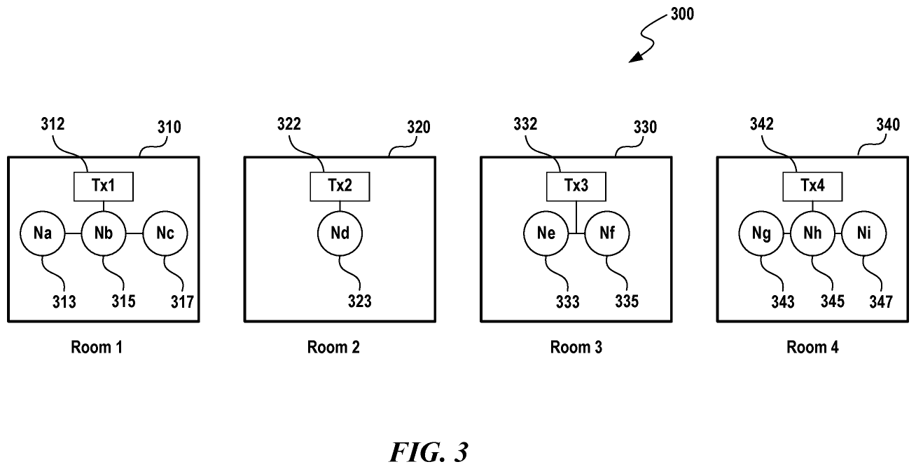

For example, FIG. 3 shows a representative block diagram of a distributed wireless charging network 300. The distributed wireless charging network 300 includes four wireless power transmitter systems: system 310, 320, 330, and 340. The wireless power transmitter systems are placed in different locations in the medical facility (e.g., in different rooms in a hospital). Each wireless power transmitter system includes a wireless power transmitter circuit (e.g., wireless power transmitter circuit 110 in FIG. 1) and one or more wireless power transmitter nodes (e.g., wireless power transmitter node 120 in FIG. 2). The wireless power transmitter systems work collectively to form a single wireless charging network 300 to wirelessly charge various receiver devices (e.g., wireless power receivers coupled or integrated into medical equipment).

The wireless power transmitter nodes are spaced at different separation distances. For example, wireless power transmitter system 310 in Room 1 has a wireless power transmitter circuit 312 and three wireless power transmitter nodes (nodes 313, 315, and 317); wireless power transmitter system 320 in Room 2 has a wireless power transmitter circuit 322 and one wireless power transmitter node (node 323); and, wireless power transmitter system 330 in Room 3 has a wireless power transmitter circuit 332 and two wireless power transmitter nodes (nodes 333, and 335). Wireless power transmitter system 340 in Room 4 has a wireless power transmitter circuit 342. Although wireless power transmitter system 340 has three nodes (nodes 343, 345, and 347) like the wireless power transmitter system 310 in Room 1, the nodes in Room 4 are spaced closer together than the nodes in Room 1 (e.g., Room 4 may be smaller than Room 1 or equipment in Room 4 requiring wireless charging may be more closely placed that equipment in Room 1, etc.).

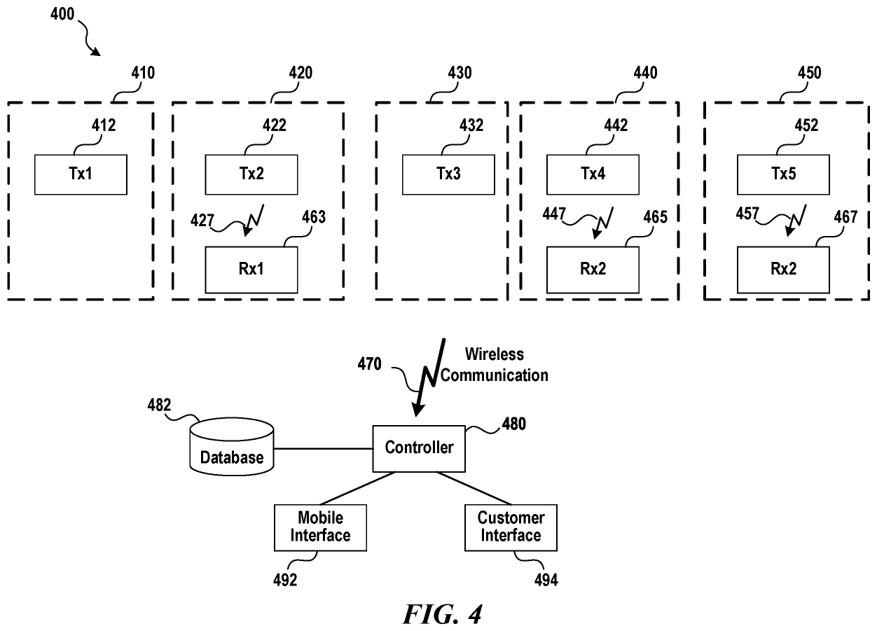

FIG. 4 is a representative block diagram of a wireless charging communication network 400. The wireless charging communication network includes several wireless power transmitter systems (e.g., five wireless power transmitter systems 412, 422, 432, 442, and 452) with each wireless power transmitter system in a different location within the building (e.g., each wireless power transmitter system placed in room 410, 420, 430, 440, and 450, respectively). As described above in relation to FIG. 3, each wireless power transmitter system includes one or more wireless power transmitter nodes where the nodes of one wireless power transmitter system can have different separation distances compared to nodes of another wireless power transmitter system.

In some embodiments, the wireless power transmitter systems communicate with a system controller 480 and/or a database 482 (e.g., via a wired communication network or a wireless communication network 470) to report the status of the distributed wireless charging network (e.g., for real-time monitoring of the distributed charging network). For example, the wireless power transmitter system can send a communication signal to the database 482 (e.g., an administrative database) when the wireless power transmitter system or its associated node(s) are activated to power a wireless charging receiver. A user of database 482 or a controller 480 can determine at any time what wireless power transmitters and nodes are enabled.

For example, the wireless power transmitter system 422 can detect the presence of a wireless charging receiver 463 by measuring the reflected impedance or based on a sensor that is triggered when a medical appliance in which the wireless charging receiver 463 is embedded in or integrated with is physically near the wireless power transmitter 422 or one of its nodes. When the wireless power transmitter system 422 detects the proximity of wireless receiver 463, it can activate power transmission to receiver 463 which ensures that the transmitters are only emitting power when a receiver (e.g., a medical device) is in the physical presence of the transmitter unit or individual node in the unit thereby conserving power and useful life of the transmitters. Furthermore, the transmitter can indicate the type of receiver device that is coupling with it based on the reflected impedance or a sensor that is triggered to obtain additional information on the charging receiver device. The wireless power transmitter system 422 (or the receiver 463) can also send a communication signal to controller 480 and/or database 482 to signal that power transmission is activated. In addition to indicating that the wireless power transmitter is enabled (i.e., power transmission is activated), the communication signal can also indicate an identifier (ID) of the wireless receiver that is proximate to the power transmitter (i.e., and ID of the receiver or medical device that caused the power transmitter to be enabled and/or that is receiving power from the particular power transmitter) or a type of wireless receiver or medical device. The transmitter or receiver can send the communication signal in real-time, in periodic intervals, or based on some event trigger (e.g., based on a query by a user of database 482 received from interfaces 492 or 494). In the example of FIG. 4, wireless power transmitter systems 422, 442, and 452 are active and transmitting power signals 427, 447, and 457 respectively to wireless receivers 463, 465, and 467 respectively. On the other hand, wireless power transmitters 412 and 432 are idle (not active or enabled), for example, because they have not detected the presence of wireless receivers.

Additionally, firmware in wireless receivers (e.g., in wireless receiver 463, 465, and 467) can monitor the battery capacity of the medical device in which they are embedded and the duration that the medical device is proximate to the corresponding transmitters and communicate this information to the controller 480 and/or the database 482 in real-time or at other periodic or event-based intervals. The wireless receivers can also communicate this information to the power transmitters and the power transmitters subsequently communicate it to the controller/database.

A user or controller can query the database 482 to determine useful information regarding the distributed wireless charging network and the medical devices based on information reported by corresponding receivers and/or transmitters. For example, the database can include real-time information on usage of individual transmitters or transmitter nodes, the duration that a receiver spends proximate to a transmitter/node (e.g., duration in a certain room or location in medical facility), the location of each receiver (i.e., location of medical equipment), and the usage of each medical device (e.g., based on frequency of recharging of the medical device or battery state of the device).

An administrator of the medical facility (e.g., hospital administrator or medical equipment purchasing manager) can use a customer interface 494 to query the database 482 to determine usage of the medical devices. Additionally, or alternatively, a controller 480 can push usage information reports or notifications to the customer interface 494 to provide users subscribed to such notifications with valuable usage information.

Additionally, a mobile interface 492 can provide users such as doctors and nurses with information on the availability and location of medical equipment in the distributed wireless charging network. For example, the users can query database 482 through the mobile interface 492, or a controller 480 can push this information to mobile interface 492 in real-time or periodically. The user can determine which medical devices are available (i.e., currently not charging or at least charged to a certain capacity) and the location of the devices, e.g., what room or physical location the devices are located based on their reported position or based on the reported association with transmitters in known locations (e.g., association with transmitters having an IDs that are associated in database 482 with known locations).

It will be appreciated that, that the wireless receiver can be coupled to the medical device or appliance in several ways and need not be directly embedded within the device. For example, in some implementations, wireless receiver can be implemented as an external accessory or add-on module or retrofitted as an after-market component instead of being integrated by the original equipment manufacturer (OEM).

Additionally, the disclosed technology can be used for other appliances not just medical devices or appliances. For example, the wireless receiver device can be embedded in, integrated with, or otherwise coupled to devices such as handheld mobile wireless communication devices (e.g., smartphones, portable hotspots, tablets, etc.), laptops, wearable devices, drones, vehicles, head-mounted displays, portable gaming consoles, game controllers, wireless routers, gateways, modems, and other fixed-wireless access devices, sensors, IoT devices such as smart home appliances, etc.

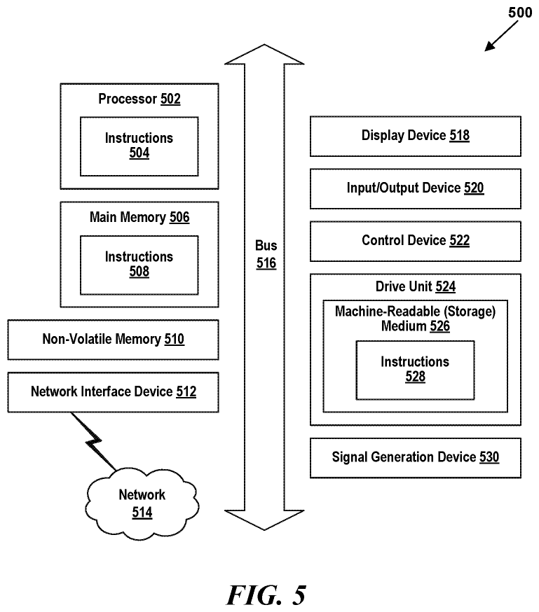

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, video display device 518, an input/output device 520, a control device 522 (e.g., keyboard and pointing device), a drive unit 524 that includes a storage medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementation, the computer system 500 can be an embedded computer system, a system-on-chip (SOC), a single-board computer system (SBC) or a distributed system such as a mesh of computer systems or include one or more cloud components in one or more networks. Where appropriate, one or more computer systems 500 can perform operations in real-time, near real-time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adaptor card, a wireless network interface card, a router, an access point, a wireless router, a switch, a multilayer switch, a protocol converter, a gateway, a bridge, bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable (storage) medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory devices 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure. It is noted that certain embodiments may include only a portion of the above-described components of the computer system 500. For example, some embodiments may simply use a processor and a memory, while some embodiments may include a communication interface.

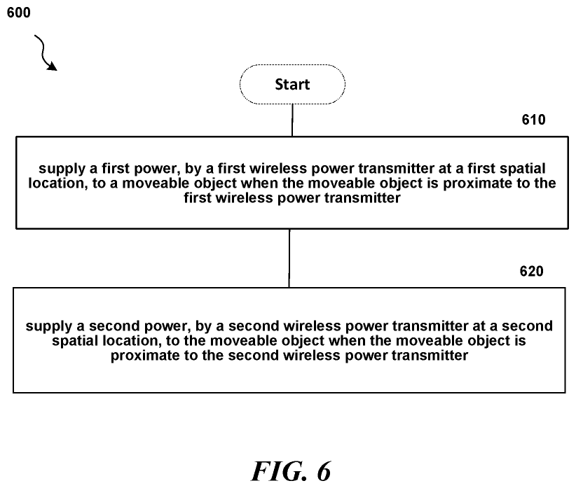

FIG. 6 is a flowchart that illustrates a process for supplying power to a moveable object (e.g., a mobile or nomadic object coupled to a wireless power receiver) based on proximity to wireless power transmitters. At block 610, a first wireless power transmitter located at a first spatial location (e.g., a certain room or location in a building) supplies power to the moveable object when the moveable object is physically proximate to the first wireless power transmitter (i.e., when the moveable object is near the first power transmitter, e.g., in the same room or vicinity or less than a few feet from the first power transmitter).

At block 620, a second wireless power transmitter supplies power to the moveable object when the moveable object is physically proximate to the second wireless power transmitter located at a second spatial location (i.e., when the moveable object is near the second power transmitter, e.g., in the same room or vicinity or less than a few feet from the second power transmitter). The second spatial location can be a different room of the building or a different location within the building that is away from the first spatial location (e.g., the moveable object at the second spatial location cannot receive power from the first wireless power transmitter in the first spatial location).

U.S. Patent Application No. 62/736,843, and PCT Application No. PCT/US2019/053266, which published as WO 2020/069198 on Apr. 2, 2020, incorporated by reference in entirety herein, describes some example parallel resonant amplifier topologies for wireless power transmitters that can be used with the technology described herein.

A listing of solutions that is preferably implemented by some embodiments can be described using the following clauses.

Clause 1. A wireless charging network comprising: a first wireless power transmitter located at a first spatial location; a second wireless power transmitter located at a second spatial location physically separate from the first spatial location, wherein the first and second wireless power transmitters are configured to provide power to a receiver device when the receiver device is in proximity thereof; and a controller communicatively coupled to the first and second wireless power transmitters, wherein the controller is configured to receive a communication signal from the first or the second wireless power transmitter, wherein the communication signal indicates that the first or the second wireless power transmitter is enabled to provide power to the receiver device. In some implementations, the type of receiver device determines how much power is output from the power transmitter (e.g., output more power to forklift instead of pushcart). The type of device can be determined from direct communication between the device and power transmitter (e.g., backscatter modulation transmission) or could be based on properties of the power coupled to the device (e.g., current drawn, reflections, etc.).

Clause 2. The wireless charging network of clause 1, wherein the first wireless power transmitter comprises a first set of wireless charging nodes and the second wireless power transmitter comprises a second set of wireless charging nodes, wherein each node of the first set and second set of wireless charging nodes comprises one or more capacitors and an antenna, wherein the one or more capacitors are tuned to substantially excite the antenna at an operating frequency of the first or second wireless power transmitter.

Clause 3. The wireless charging network of clause 2, wherein the first set of wireless charging nodes comprises a different number of wireless charging nodes than the second set of wireless charging nodes.

Clause 4. The wireless charging network of clause 2, wherein the first set of wireless charging nodes comprises wireless charging nodes spaced at a first distance from each other and the second set of wireless charging nodes comprises wireless charging nodes spaced at a second distance from each other, wherein the first distance and second distance are different.

Clause 5. The wireless charging network of clause 1, wherein the receiver device is embedded in a medical device, and the first spatial location and the second spatial location are separate rooms in a medical facility.

Clause 6. The wireless charging network of clause 5, wherein the first wireless power transmitter is further configured to detect a physical proximity of the medical device to the first wireless power transmitter and enable a power transmission from the first wireless power transmitter to the medical device when the medical device is detected to be physically proximate to the first wireless power transmitter. The presence of the moveable/mobile object could be binary in nature (e.g., object is present or not present in charging zone around power transmitter or in the room where the transmitter is located) or the presence could be analog (e.g., based on current draw or reflected impedance, the object can be detected to be within a certain distance from the power transmitter). Proximity of the object can also be determined in other ways such as indoor positioning (e.g., Wi-Fi, Bluetooth, NFC, or other sensor-based positioning) or GPS/GNSS positioning within the building or room. In some implementations, the amount of power output from the power transmitter is based on how far the device is to the power transmitter.

Clause 7. The wireless charging network of clause 6, wherein the first wireless power transmitter is further configured to send a communication signal to the controller to indicate a charge status of the medical device. The communication signal may use an industry standard protocol such as WI-FI or BLUETOOTH or using modulation of the power signal itself.

Clause 8. The wireless charging network of clause 6, wherein the first wireless power transmitter is further configured to send a communication signal to the controller to indicate a duration in which the medical device has been physically proximate to the first wireless power transmitter.

Clause 9. The wireless charging network comprising of clause 6, further comprising: a database coupled to the controller; and, a first user interface and a second user interface coupled to the controller and to the database, wherein the first user interface is configured to query the database for at least one of a spatial location of the medical device, a charge status of the medical device, or a duration that the medical device has been in physical proximity to a wireless power transmitter, and wherein the second user interface is configured to query the database for at least one of a number of times in a given period of time that the medical device has received power from the first or the second wireless power transmitter, or the duration that the medical device has been in physical proximity to the wireless power transmitter.

Clause 10. A method implemented on a wireless charging network for supplying power to moveable objects, the method comprising: supplying a first power, by a first wireless power transmitter located at a first spatial location, to a moveable object when the moveable object is proximate to the first wireless power transmitter; and, supplying a second power, by a second wireless power transmitter located at a second spatial location physically separate from the first spatial location, to the moveable object when the moveable object is proximate to the second wireless power transmitter.

Clause 11. The method of clause 10, wherein supplying the first power to the first moveable object comprises: detecting that the moveable object is in physical proximity to the first wireless power transmitter; and, enabling the first wireless power transmitter in response to detecting that the moveable object is in physical proximity to the first wireless power transmitter.

Clause 12. The method of clause 11, wherein detecting that the moveable object is in physical proximity to the first wireless power transmitter comprises measuring a reflected impedance in the first wireless power transmitter.

Clause 13. The method of clause 11, further comprising transmitting, by the first wireless power transmitter, a communication signal to a database in the wireless charging network in response to enabling the first wireless power transmitter, wherein the communication signal indicates that the first wireless power transmitter has been enabled.

Clause 14. The method of clause 13, wherein the communication signal further indicates a charge status of the moveable object or a type of moveable object.

Clause 15. The method of clause 13, wherein the communication signal further indicates a duration in which the moveable object has been proximate to the first wireless power transmitter.

Clause 16. A system comprising: a plurality of wireless power transmitters configured to provide wireless power to one or more moveable objects; and, a controller configured to receive a communication signal to indicate that a wireless power transmitter in the plurality of wireless power transmitters is enabled.

Clause 17. The system of clause 16, wherein each wireless power transmitter in the plurality of wireless power transmitters is located at a physically separate spatial location along a trajectory of the one or more moveable objects.

Clause 18. The system of clause 16, wherein the one or more moveable objects comprise one or more medical devices configured to receive wireless power from the plurality of wireless power transmitters.

### Remarks

The figures and above description provide a brief, general description of a suitable environment in which the invention can be implemented. The above Detailed Description of examples of the invention is not intended to be exhaustive or to limit the invention to the precise form disclosed above. While specific examples for the invention are described above for illustrative purposes, various equivalent modifications are possible within the scope of the invention, as those skilled in the relevant art will recognize. For example, while processes or blocks are presented in a given order, alternative implementations can perform routines having steps/blocks, or employ systems having blocks, in a different order, and some processes or blocks can be deleted, moved, added, subdivided, combined, or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further any specific numbers noted herein are only examples: alternative implementations can employ differing values or ranges.

These and other changes can be made to the invention considering the above Detailed Description. While the above description describes certain examples of the invention, and describes the best mode contemplated, no matter how detailed the above appears in text, the invention can be practiced in many ways. Details of the system can vary considerably in its specific implementation, while still being encompassed by the invention disclosed herein. As noted above, terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

1. A wireless charging network comprising:
a first wireless power transmitter located at a first spatial location;
a second wireless power transmitter located at a second spatial location physically separate from the first spatial location,
wherein the first and second wireless power transmitters are configured to provide power to a receiver device when the receiver device is in proximity thereof; and
a controller communicatively coupled to the first and second wireless power transmitters,
wherein the controller is configured to receive a communication signal from the first or the second wireless power transmitter, wherein the communication signal indicates that the first or the second wireless power transmitter is enabled to provide power to the receiver device.

2. The wireless charging network of claim 1, wherein the first wireless power transmitter comprises a first set of wireless charging nodes and the second wireless power transmitter comprises a second set of wireless charging nodes, wherein each node of the first set and the second set of wireless charging nodes comprises one or more capacitors and an antenna, wherein the one or more capacitors are tuned to substantially excite the antenna at an operating frequency of the first or second wireless power transmitter.

3. The wireless charging network of claim 2, wherein the first set of wireless charging nodes comprises a different number of wireless charging nodes than the second set of wireless charging nodes.

4. The wireless charging network of claim 2, wherein the first set of wireless charging nodes comprises wireless charging nodes spaced at a first distance from each other and the second set of wireless charging nodes comprises wireless charging nodes spaced at a second distance from each other, wherein the first distance and the second distance are different.

5. The wireless charging network of claim 1, wherein the receiver device is embedded in a medical device, and the first spatial location and the second spatial location are separate rooms in a medical facility.

6. The wireless charging network of claim 5, wherein the first wireless power transmitter is further configured to detect a physical proximity of the medical device to the first wireless power transmitter and enable a power transmission from the first wireless power transmitter to the medical device when the medical device is detected to be physically proximate to the first wireless power transmitter.

7. The wireless charging network of claim 6, wherein the first wireless power transmitter is further configured to send a communication signal to the controller to indicate a charge status of the medical device.

8. The wireless charging network of claim 6, wherein the first wireless power transmitter is further configured to send a communication signal to the controller to indicate a duration in which the medical device has been physically proximate to the first wireless power transmitter.

9. The wireless charging network comprising of claim 6, further comprising:
a database coupled to the controller; and,
a first user interface and a second user interface coupled to the controller and to the database,
wherein the first user interface is configured to query the database for at least one of a spatial location of the medical device, a charge status of the medical device, or a duration that the medical device has been in physical proximity to a wireless power transmitter, and
wherein the second user interface is configured to query the database for at least one of a number of times in a given period of time that the medical device has received power from the first or the second wireless power transmitter, or the duration that the medical device has been in physical proximity to the wireless power transmitter.

10. A method implemented on a wireless charging network for supplying power to moveable objects, the method comprising:
supplying a first power, by a first wireless power transmitter located at a first spatial location, to a moveable object when the moveable object is proximate to the first wireless power transmitter; and,
supplying a second power, by a second wireless power transmitter located at a second spatial location physically separate from the first spatial location, to the moveable object when the moveable object is proximate to the second wireless power transmitter.

11. The method of claim 10, wherein supplying the first power to the moveable object comprises:
detecting that the moveable object is in physical proximity to the first wireless power transmitter; and,
enabling the first wireless power transmitter in response to detecting that the moveable object is in physical proximity to the first wireless power transmitter.

12. The method of claim 11, wherein detecting that the moveable object is in physical proximity to the first wireless power transmitter comprises measuring a reflected impedance in the first wireless power transmitter.

13. The method of claim 11, further comprising transmitting, by the first wireless power transmitter, a communication signal to a database in the wireless charging network in response to enabling the first wireless power transmitter, wherein the communication signal indicates that the first wireless power transmitter has been enabled.

14. The method of claim 13, wherein the communication signal further indicates a charge status of the moveable object or a type of moveable object.

15. The method of claim 13, wherein the communication signal further indicates a duration in which the moveable object has been proximate to the first wireless power transmitter.

16. A system comprising:
a plurality of wireless power transmitters configured to provide wireless power to one or more moveable objects; and,
a controller configured to receive a communication signal to indicate that a wireless power transmitter in the plurality of wireless power transmitters is enabled.

17. The system of claim 16, wherein each wireless power transmitter in the plurality of wireless power transmitters is located at a physically separate spatial location along a trajectory of the one or more moveable objects.

18. The system of claim 16, wherein the one or more moveable objects comprise one or more medical devices configured to receive wireless power from the plurality of wireless power transmitters.

19. (canceled)
